(19) United States
(12) Patent Application Publication
(10) Pub. No.: US 2010/0282867 A1
(43) Pub. Date: Nov. 11, 2010

(54) SELF-POWERED NOZZLE ASSEMBLY WITH HYDRAULIC DAMPENER FOR CLEANING TANKS

(76) Inventor: Donald D. Savard, Edmonton (CA)

Correspondence Address: VALENTINE A COTTRILL;SUSAN TANDAN, 50 QUEEN STREET NORTH, STE. 1020, P.O. BOX 2248, KITCHENER, ON, N2H6M2, CA

(21) Appl. No.: 12/810,421

(22) PCT Filed: Jan. 21, 2009
(86) PCT No.: PCT/CA09/00057

§ 371 Date: Jun. 24, 2010

(30) Foreign Application Priority Data
Jan. 29, 2008 (CA) 2622314

(51) Int. Cl. B05B 3/04

(52) U.S. Cl. 239/381

(57) ABSTRACT

A self-powered nozzle assembly for use within a tank has a stationary body and a rotatable body rotatably connected to and in fluid communication with the stationary body. The rotatable body has an axis of rotation with at least one offset nozzle such that, as fluid is ejected from the at least one offset nozzle, the fluid applies a rotational force to the rotatable body. A rotational speed dampener is connected to the rotatable body.

### FIELD

The present patent document relates to a self-powered nozzle assembly, such as for use in mixing or cleaning within a tank, with a hydraulic dampener to control the rotational speed.

### BACKGROUND

International patent application no. WO 97/27951US (Butterworth Systems, Inc.) entitled “Improved Tank Cleaning Device” describes a rotating nozzle assembly used to clean the interior of a tank.

### SUMMARY

There is provided a self-powered nozzle assembly for use within a tank. The self-powered nozzle assembly has a stationary body having a fluid input, and a rotatable body rotatably connected to and in fluid communication with the stationary body. The rotatable body has an axis of rotation with at least one offset nozzle such that, as fluid is ejected from the at least one offset nozzle, the fluid applies a rotational force to the rotatable body about the axis of rotation. A rotational speed dampener is connected to the rotatable body.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side view in section of the self-powered nozzle assembly mounted within a tank.

FIG. 2 is a detailed side view in section of the hydraulic dampener.

FIG. 3 is a detailed top plan view of the rotatable body.

### DETAILED DESCRIPTION

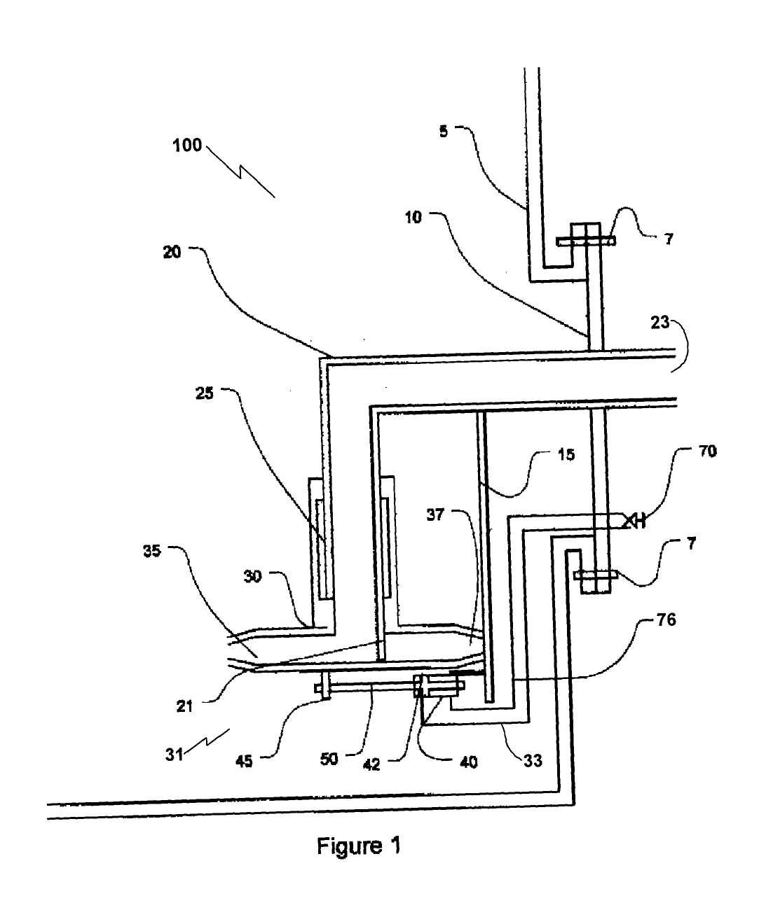

A self-powered nozzle assembly for use within a tank, generally identified by reference numeral 100, will now be described with reference to FIG. 1 through 3.

This assembly relates to a tank cleaning and fluid mixing machine designed specifically to reduce the complexity of existing apparatuses. Sludge collects on the bottom of storage as wax, sediment, and other materials that are entrained in the fluid accumulate, or combine and drop to the bottom of the tank. The machine provides a means to re-suspended the material deposited on the tank bottom with the fluid from the tank or new fluid so that the sludge can be pumped from the tank. The rotating nozzles will move in a circular fashion so that the complete bottom of the tank is impacted buy the fluid being discharged from the nozzle. The rotating mechanism is designed so that the majority of the fluid is directed to the nozzle that is directed to the centre of the tank. The rotating mixer can also be used to blend different types of crude or fluid together so that they become a homogenous mixture. The mixer can be placed in the centre of the tank so that both nozzles can be used.

### Structure and Relationship of Parts

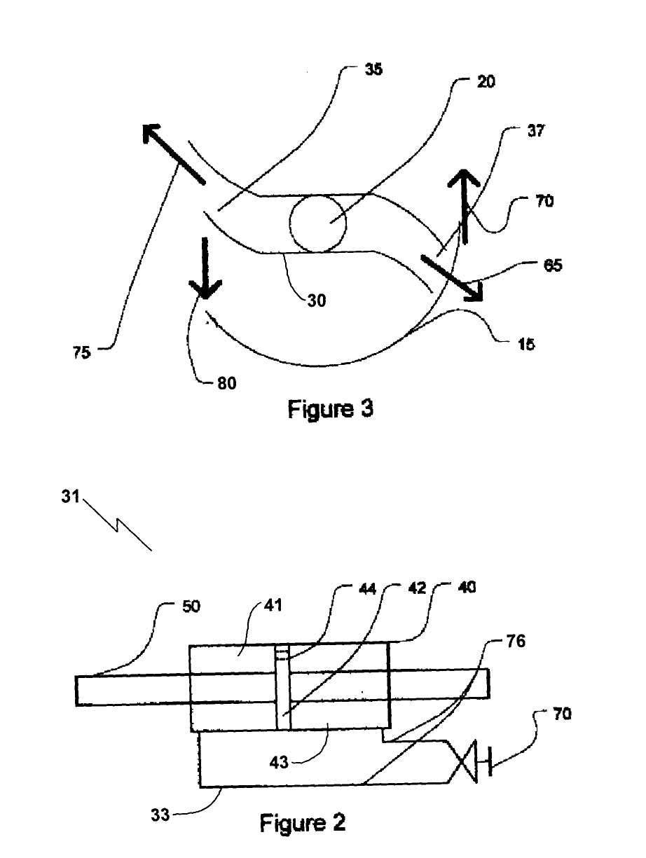

Referring to FIG. 1, there is shown a self powered machine, or nozzle assembly 100 that may be used for removing sludge and mixing fluids in a tank. The machine 100 comprises a nozzle mechanism 30, or rotating body, that rotates around an inlet pipe 20, with two nozzles that are offset to generate a rotational force in order to rotate mechanism 30 around inlet pipe 20. An internal baffle plate 21 or an external baffle plate 15 ensures that the majority of the flow is directed to the centre of the tank. A speed control mechanism shown in FIG. 2 allows a user to set the desired rotational speed and, if required, can be configured to allow the user to adjust the speed from the exterior of the tank.

In particular, referring to FIG. 1, self-powered nozzle assembly 100 includes a stationary body 20 having a fluid input 23. In the depicted embodiment, stationary body 20 is an inlet pipe, or flow pipe. A rotatable body 30, which may also be referred to as a nozzle mechanism, is rotatably connected to, and in fluid communication with, stationary body 20. Rotatable body 30 has an axis of rotation about which it rotates on bearings 25. It is preferred that rotatable body 30 be designed such that the internal components are maintained within a closed environment to prolong the useful lifespan of assembly 100. Rotatable body also has a first offset nozzle 35 and a second offset nozzle 37. These are offset from the axis of rotation, such that, as fluid is ejected from nozzles 35 and 37, the fluid applies a rotational force to rotatable body about the axis of rotation. It will be understood that rotatable body 30 may have any number of nozzles. It will also be appreciated that not all nozzles need to be offset, or offset in the same direction. However, the nozzles must be arranged such that there is a net rotational force acting on the rotatable body.

In order to control the rotational speed of rotatable body 30, a rotational speed dampener is connected to the rotatable body, indicated generally by reference numeral 31. In the example shown and discussed below, rotational speed dampener is a hydraulic dampener, which reduces the rate of flow to restrict the speed. It will be understood that other types of dampeners may also be used, such as dampeners based on friction. Referring to FIG. 2, rotational speed dampener includes a hydraulic cylinder 40, a piston 42 positioned within hydraulic cylinder 40, and a fluid bypass 33. Piston 42 divides hydraulic cylinder 40 into a first chamber 41 and a second chamber 43. Referring to FIG. 1, piston 42 is connected to rotatable body 30 by a rod 50 that joins piston 42 and a flange 45 that is in turn attached at a point on rotatable body 30 that is offset from the axis of rotation. This is done such that, as rotatable body 30 rotates, piston 42 moves within hydraulic cylinder 40. As shown, rod 50 extends the entire length of hydraulic cylinder 40 to ensure maintain the same volume of fluid in both chambers 41 and 43, which would otherwise result in a different rotational speed, depending on the direction of motion of piston 42. The speed control mechanism as described intended to allow rotatable body 30 to rotate using an existing power source, namely, the pressurized fluid, while minimizing the amount of energy that is taken from the fluid. If other dampeners are used, the speed control mechanism will relate to the principle they are based upon.

Referring to FIG. 2, fluid bypass 33 permits fluid within hydraulic cylinder 40 to flow from first chamber 41 to second chamber 43. Fluid bypass 33 may be an aperture 44 in piston 42 that extends between a first face and a second face of piston 42. Alternatively, fluid bypass 33 may be an external flowpath 76 that has a control valve 70 for controlling the amount of fluid flow through fluid bypass 33, which in turn controls the rotational speed of rotational body 30. This may be positioned at any convenient location, such as outside the tank 5 in which apparatus 100 is installed. Other means of adjusting or controlling the rate of fluid flow through fluid bypass 33 may also be used.

Referring to FIG. 1, in order to control the flow of fluid from rotatable body 30, rotatable body 30 may have a stationary internal baffle 21 that restricts or blocks flow when one of the nozzles is pointed in a certain direction. There may also be an external baffle 15 positioned adjacent to rotatable body 30 for restricting flow in a specified direction.

### Operation

FIG. 1 shows assembly 100 attached by bolting 7 to tank 5 on flange 10. It will be understood that assembly 100 may be attached by other suitable means and in other suitable locations. Flow pipe 20 extends through flange 10 and can be set in either a downward or upward position. Fluid is introduced into the tank through flow pipe 20. Rotating body 30 has two nozzles 35 and 37 that are offset from the axis of rotation, and are opposed to each other. FIG. 3 shows the nozzles 35 and 37 positioned at an angle so that fluid exiting nozzles 35 and 37 will apply forces 65, 70 and 75, 80 to cause the rotating body 30 to rotate on bearings 25. Referring to FIG. 2, to control the rate of rotation, a control mechanism rod 50 is connected to rotating body 30, with a bracket or flange 45. The rotation of body 30 causes piston 42 in cylinder 40 to move from side to side. As fluid is virtually incompressible, the rate piston 42 moves can be controlled by controlling the transfer of fluid from one side of piston 42 to the other. The rate of fluid transfer can be fixed by either placing a small hole 44 in piston 42, or variable by having control lines 76 attached to a metering valve 70. The use of metering 70 valve will allow the adjustment of fluid flow that will control rotation speed from the exterior of the tank. FIG. 3 shows baffle 15 is positioned so that flow from the nozzle 37 that is pointing against the tank wall will be restricted. This will increase the fluid flow through of the non restricted nozzle 35. A baffle 21 can installed in the interior of flow pipe 20 to restrict flow to the nozzle that is pointing to the centre of the tank.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A self-powered nozzle assembly for use within a tank, comprising:
a stationary body having a fluid input;
a rotatable body rotatably connected to and in fluid communication with the stationary body, the rotatable body having an axis of rotation with at least one offset nozzle such that, as fluid is ejected from the at least one offset nozzle, the fluid applies a rotational force to the rotatable body about the axis of rotation; and
a rotational speed dampener connected to the rotatable body.

2. The self-powered nozzle assembly of claim 1, wherein the rotational speed dampener comprises:
a hydraulic cylinder;
a piston positioned within the hydraulic cylinder, the piston dividing the hydraulic cylinder into a first chamber and a second chamber, the piston being connected to the rotatable body at a point offset from the axis of rotation such that as the rotatable body rotates, the piston moves within the hydraulic cylinder; and
a fluid bypass permitting fluid within the hydraulic cylinder to flow from the first chamber to the second chamber.

3. The self-powered nozzle assembly of claim 1, wherein the rotatable body comprises a first offset nozzle and a second offset nozzle, wherein fluid being ejected from each of the first offset nozzle and the second offset nozzle applies a rotational force to the rotatable body.

4. The self-powered nozzle assembly of claim 1, wherein the rotatable body comprises an internal baffle for restricting flow in a specified direction.

5. The self-powered nozzle assembly of claim 1, further comprising an external baffle for restricting flow in a specified direction.

6. The self-powered nozzle assembly of claim 2, wherein the fluid bypass of the rotational speed dampener comprises an aperture in the piston extending between a first face and a second face of the piston.

7. The self-powered nozzle assembly of claim 2, wherein the fluid bypass of the rotational speed dampener is an external flowpath.

8. The self-powered nozzle assembly of claim 6, wherein the external flowpath comprises a control valve for controlling the amount of fluid flow through the fluid bypass.

9. The self-powered nozzle assembly of claim 1, wherein the dampening effect of the rotational speed dampener is adjustable.

10. The self-powered nozzle assembly of claim 2, wherein a rate of fluid flow through the fluid bypass is adjustable.
